(19) United States
(12) Patent Application Publication
(10) Pub. No.: US 2022/0232476 A1
(43) Pub. Date: Jul. 21, 2022

(54) ADAPTIVE WUS TRANSMISSION

(71) Applicant: Telefonaktiebolaget LM Ericsson (publ), Stockholm (SE)

(72) Inventors: Andres REIAL, Lomma (SE); Sina MALEKI, Malmö (SE); Ilmiawan SHUBHI, Malmö (SE); Leif WILHELMSSON, Lund (SE)

(21) Appl. No.: 17/633,832

(22) PCT Filed: Aug. 11, 2020
(86) PCT No.: PCT/EP2020/072511

§ 371 Date: Feb. 8, 2022

Related U.S. Application Data
(60) Provisional application No. 62/887,223, filed on Aug. 15, 2019.

(51) Int. Cl. H04W 52/02; H04W 24/10

(52) U.S. Cl. CPC H04W 52/0232; H04W 24/10; H04W 52/0274

(57) ABSTRACT

A network node and a method of transmitting control information to a wireless device performed by the network node. The method includes determining a wake-up signal, WUS, transmission robustness goal, determining a link quality between the network node and the wireless device, selecting a WUS transmission mode based on the robustness goal and the link quality, applying the selected WUS transmission mode such that a transmitted WUS enables the wireless device to wake up to receive control information, and transmitting the control information to the wireless device.

### TECHNICAL FIELD

The present disclosure generally relates to method of transmitting control information in a wireless communication system to a wireless device performed by a network node of the wireless communication system, such a network node, and a computer program for implementing the method in the network node.

### BACKGROUND

One of the power consuming activities of wireless devices in a communication system, often referred to as user equipment (UE), which are in an RRC_CONNECTED mode (Radio Resource Control) is to monitor Physical Downlink Control Channel (PDCCH) for control signals. In this activity, the UE would perform blind detection in its configured control resource sets (CORESETs) to identify whether there is a PDCCH sent to it and act accordingly. On the other hand, the UE is not scheduled in most PDCCH monitoring occasions (MOs) and thus, the UE monitoring is in almost all cases a waste of energy.

In 3^{rd} Generation Partnership Project (3GPP) Release 15, discontinuous reception (DRX) is used to reduce the energy consumption. In DRX, the UE will start an inactivity timer after the scheduling PDCCH is successfully decoded by the UE. Once the inactivity timer expires, the UE will go to sleep following a certain pattern of sleep and ON-duration, the so-called DRX cycle. Using this DRX technique, the network (NW) will only transmit the scheduling PDCCH during the ON-duration. The UE, therefore, will only monitor the PDCCH in those ON-durations and could go to sleep between the ON-duration and therefore saves energy. It should be noted, however, that the DRX cycles still require the UE to wake-up quite frequently, especially when the DRX cycle length is relatively short. It will also waste a notable amount of energy when the ON duration is relatively long compared to duration of the DRX cycle.

Given the problems described above, techniques that can reduce unnecessary PDCCH MOs during the ON-duration of the DRX cycle will be beneficial. Here, a wake-up signal (WUS) can be considered as one of the efficient solutions to improve UE power consumption. Using WUS, the UE will wake-up and monitor the PDCCH in the DRX ON-duration only when a WUS is detected prior to the ON-duration. The WUS itself, will be sent by the NW, from e.g. a serving network node such as a gNodeB, when there is data in the buffer to be transmitted to the UE. By allowing the UE to conduct PDCCH monitoring only when there will be PDSCH, the UE energy consumption can be significantly reduced. In addition, WUS monitoring can be set to be more power efficient compared with that of the normal PDCCH monitoring and thus, improves the UE energy efficiency even further.

One of the problems of using WUS is due to that the UE may not always successfully detect/decode the WUS in the WUS MOs even when the network node actually sends the WUS to wake-up the UE for the next ON-duration. In this case, as the UE remains in a sleep state, the UE will miss the scheduling PDCCH from the NW during the ON-duration. A data transmission through Physical Downlink Shared Channel (PDSCH) following the PDCCH and carrying e.g. layer 1 data, therefore, cannot be received by the UE.

This circumstance increases the latency and reduces the throughput. Even worse, when the UE misses the PDSCH transmission from the NW for several consecutive occasions, and does not provide expected ACK/NACK feedback, the UE can be considered by the NW to be out of range. In this condition, the UE would restart the connection set-up which requires a significant amount of power. The potential power saving, therefore, can be significantly reduced.

Thus, a missed WUS may result in multiple missed PDCCH/PDSCH and even trigger radio link failure (RLF) status. To ensure that usage of WUS actually results in a reduction of the energy consumption, therefore, WUS reception is desired to be robust, which however is more resource consuming.

It is therefore a desire to provide a solution where WUS robustness and resource consumption are balanced.

The above information disclosed in this Background section is only for enhancement of understanding of the background of the disclosure and therefore it may contain information that does not form the prior art that is already known to a person of ordinary skill in the art.

### SUMMARY

The disclosure is based on the inventors' realization that a straightforward solution for WUS transmission with most robust resources (e.g. higher aggregation level (AL), higher power, multiple WUS occasions/transmissions) is required to ensure that all UEs can successfully detect/decode WUS, especially when ambitious format is used (e.g. high payload in the WUS, etc.). This solution, however, has a high NW resource cost and may lead to inability to schedule WUS transmissions in some cases due to PDCCH resource shortage. The inventors' realization that a need for improved approaches for WUS configuration that could avoid excessive NW resource usage have made them realize that the NW node can select a WUS configuration based on UE link quality estimate, which will balance WUS robustness and resource consumption.

According to a first aspect, there is provided a method of transmitting control information in a wireless communication system to a wireless device performed by a network node of the wireless communication system. At least two wake-up signal, WUS, transmission modes are selectable. The method comprises determining a link quality between the network node and the wireless device, selecting a WUS transmission mode based on the link quality, and applying the selected WUS transmission mode such that when transmitting the control information to the wireless device, the wireless device is enabled to be awake to receive the control information.

The selecting of the WUS transmission mode may comprise selecting a WUS transmission mode implicating not applying a WUS when link quality is below a first threshold, and selecting a WUS transmission mode implicating applying a WUS when link quality is above the first threshold.

The method may comprise configuring, by the network node, the wireless device to the selected WUS transmission mode. The configuring of the wireless device may comprise transmitting a control message to the wireless device about the selected WUS transmission mode.

The method may comprise determining a WUS transmission robustness goal, wherein the selecting of the WUS transmission mode may further be based on the WUS transmission robustness goal. The determining of the WUS transmission robustness goal may be based on a maximum allowable WUS missed detection rate.

The determining of the link quality to use for the selecting of the WUS transmission mode may be based on measurement reports from the wireless device including at least one of, Channel State Information Reference Signal, CSI-RS, report, beam management, BM, report, link adaptation, LA, report, and sounding reference signal, SRS, transmission. The determining of the link quality to use for the selecting of the WUS transmission mode may be based on quality metric including at least one of Reference Signal Receive Power, RSRP, Signal-to-Interference and Noise Ratio, SINR, and Channel Quality Indicator, CQI. The determining of the link quality to use for the selecting of the WUS transmission mode may be based on a historical modulation and coding scheme, MCS, format for WUS. The determining of the link quality to use for the selecting of the WUS transmission mode may be based on a noise figure relation between a Wake-Up Radio, WUR, receiver or receiver configuration used for receiving the WUS, and a receiver or receiver configuration used for non-WUS signals.

The selected WUS mode may comprise a configuration of at least one of: search space and control resource set, bandwidth part, offset in time or frequency, signal type, signal format, power, payload size, code rate, bandwidth, aggregation level, and modulation and coding.

The method may comprise grouping a plurality of wireless terminals into a group, and transmitting control information to the wireless devices of the group. The plurality of wireless devices of the group may be grouped based on having same selected WUS transmission mode, having matching link quality, having same allocated bandwidth, having same control information configuration, having same synchronisation configuration, or having same WUS monitoring occasion configuration, or any combination thereof. The method may comprise transmitting a group-WUS targeting multiple wireless devices, wherein a group-WUS format may be selected to match a link quality of the wireless device with a worst channel in the group comprising the multiple wireless devices. A bitmap in Downlink Control Information, DCI, may indicate which wireless devices should wake up in a next on-duration. A group WUS-Radio Network Temporary Identifier, RNTI, may be associated to the wireless devices within a same group.

The selection of the WUS transmission mode may further be based on a discontinuous reception configuration applied for the wireless device.

According to a second aspect, there is provided a network node arranged to transmit control information in a wireless communication system to a wireless device. At least two wake-up signal, WUS, transmission modes are selectable. The network node comprises a transceiver and a controller. The controller is arranged to determine a link quality between the network node and the wireless device, select a WUS transmission mode based on the link quality, and applying the selected WUS transmission mode such that when the transceiver transmits the control information to the wireless device, the wireless device is enabled to be awake to receive the control information.

The controller may be arranged to select the WUS transmission mode by selecting a WUS transmission mode implicating not applying a WUS when link quality is below a first threshold, and selecting a WUS transmission mode implicating applying a WUS when link quality is above the first threshold.

The controller may be arranged to configure the wireless device to the selected WUS transmission mode. The controller may be arranged to configure the wireless device by providing a control message about the selected WUS transmission mode, and the transceiver may be arranged to transmit the control message to the wireless device about the selected WUS transmission mode.

The controller may be arranged to determine a wake-up signal, WUS, transmission robustness goal, and further be configured to select the WUS transmission mode based on the WUS transmission robustness goal. The controller may be arranged to determine the WUS transmission robustness goal based on a maximum allowable WUS missed detection rate.

The link quality to use for the selection of the WUS transmission mode may be based on measurement reports from the wireless device including at least one of Channel State Information Reference Signal, CSI-RS, report, beam management, BM, report, link adaptation, LA, report, and sounding reference signal, SRS, transmission. The link quality to use for the selection of the WUS transmission mode may be based on quality metric including at least one of Reference Signal Receive Power, RSRP, Signal-to-Interference and Noise Ratio, SINR, and Channel Quality Indicator, CQI. The link quality to use for the selection of the WUS transmission mode may be based on a historical modulation and coding scheme, MCS, format for WUS. The link quality to use for the selection of the WUS transmission mode may be based on a noise figure relation between a Wake-Up Radio, WUR, receiver or receiver configuration used for receiving the WUS, and a receiver or receiver configuration used for non-WUS signals.

The selected WUS mode may comprise a configuration of at least one of: search space and control resource set, bandwidth part, offset in time or frequency, signal type, signal format, power, payload size, code rate, bandwidth, aggregation level, and modulation and coding.

The controller may be arranged to group a plurality of wireless terminals into a group, and the transceiver may be arranged to transmit control information to the wireless terminals of the group. The plurality of wireless devices of the group may be grouped based on having same selected WUS transmission mode, having matching link quality, having same allocated bandwidth, having same control information configuration, having same synchronisation configuration, or having same WUS monitoring occasion configuration, or any combination thereof. The network node may be arranged to transmit a group-WUS targeting multiple wireless devices, wherein a group-WUS format may be selected to match a link quality of the wireless device with a worst channel in the group comprising the multiple wireless devices. A bitmap in Downlink Control Information, DCI, may indicate which wireless devices should wake up in a next on-duration. A group WUS-Radio Network Temporary Identifier, RNTI, may be associated to the wireless devices within a same group.

The controller may be arranged to select the WUS transmission mode based on a discontinuous reception configuration applied for the wireless device.

According to a third aspect, there is provided a computer program comprising instructions which, when executed on a processor of a network node causes the network node to perform the method according to the first aspect.

### BRIEF DESCRIPTION OF THE DRAWINGS

The above, as well as additional objects, features and advantages of the present disclosure, will be better understood through the following illustrative and non-limiting detailed description of preferred embodiments of the present disclosure, with reference to the appended drawings.

FIG. 1 is a flow chart illustrating a method according to an embodiment.

FIG. 2 is a block diagram schematically illustrating a network node according to an embodiment.

FIG. 3 schematically illustrates a computer-readable medium and a processing device.

FIG. 4 illustrates a wireless network including network nodes and a wireless communication device.

### DETAILED DESCRIPTION

A network node and a method of transmitting control information in a wireless communication system to a wireless device, such as a UE, performed by the network (NW) node of the wireless communication system is suggested in this disclosure. The NW node selects a WUS configuration, where the configuration may include one or more of presence, signal type, signal format, power, payload size, code rate, BW/AL, etc., based on UE link quality estimate, which may be based on one or more of UE measurement reports, Beam Management (BM), Link Adaptation (LA) reports, Sounding Reference Signal (SRS) measurements, Modulation and Coding Scheme (MCS) history, etc., and capability and operating mode (e.g. number of antennas, bandwidth (BW) limits, etc.

The NW node, e.g. a gNB, may configure the UE with a single WUS format or configure it with multiple formats and select one of them for transmission at different times. The UE may then check multiple formats in a blind detection manner, which can be done, for example, by starting from the most robust, starting from the least robust, or even conducted in a parallel manner. The NW node may signal the wireless device about selected WUS transmission mode, e.g. about WUS configuration in sense of signal type, signal format, power, payload size, code rate, bandwidth, aggregation level, modulation, etc. For example, two or more WUS configurations may be applicable, and the signalling may be one bit or more indicating the configuration. As discussed above, the signalling may indicate a group of configurations, among which the UE may do some blind detection. As also discussed above, the selected WUS transmission mode may also include the “no WUS” alternative, e.g. when a bad link is discovered. This may be signalled through the same mechanism. A benefit of having the “no WUS” alternative is that RLF may be avoided at least due to missing a WUS when the link is bad. Another benefit is that the bad link may require too much NW resources from the WUS to provide sufficient WUS performance, and not applying WUS may be a better balance of operation robustness and resource consumption.

As a special case, the NW node may choose not to configure a WUS for UEs with link quality below a threshold, in order to avoid spending excessive resources to guarantee the required WUS performance. A WUS transmission mode would implicate not applying a WUS when link quality is below a first threshold, whereas the WUS transmission mode would implicate applying a WUS when link quality is above the first threshold.

Additionally, the NW node may group (and regroup) UEs for group-WUS transmission to ensure that UEs targeted in a given transmission have similar signal quality requirements.

The suggested solutions may enable robust WUS transmission on a per UE basis (or per group of UEs having similar signal quality requirements) and avoid over-dimensioning and excessive NW resource usage.

The NW node selects a WUS signal format based on UE link quality estimate. The UE capability and operating mode may also be taken into account. The NW node may configure the UE with a single WUS format or with multiple formats. In the latter case, the NW node chooses one of the formats for transmission at a given time, e.g. based on current conditions. The UE can then e.g., check multiple formats in a blind detection manner. In a related realization, the NW may configure the UE to discard some options, e.g., to not configure the UE with a higher AL than a specific one, e.g. AL 4.

If a UE's link condition is poor, the NW node may choose not to configure a WUS for the UEs, in order to avoid expending excessive resources to guarantee the required WUS performance. E.g., the NW node can use a Channel State Information (CSI) report, or SRS transmission of the UE in order to estimate the channel quality. It may happen that the UE's channel quality is good enough for WUS configuration at one instance of time, however, the quality reduces at another instance of time, and thus the NW node may decide to reconfigure the UE and change WUS transmission mode, which may include to change or even remove the WUS configuration. The NW may consider the average channel condition, and if it is below a specific threshold, decide to not configure the WUS. A robust implementation is also possible, where the NW considers an additional offset (deterministic or statistical one) to be added to the channel quality, or the related threshold in order to configure or not configure WUS. Furthermore, the NW may decide to configure WUS for some ON durations but not for all. Again, this may depend on the channel quality or other robustness measures. E.g., if the channel condition is very good, the NW node may decide to configure WUS to the UE for all the ON durations, however if it is between specific values, configure the WUS for some but not all UEs or not all ON durations, and if it is not reliable enough, not configure WUS at all.

In group UE transmissions, the group WUS format may be selected to match the link quality of the UE with the worst channel conditions within the group. The NW node may group UEs to obtain groups with similar channel qualities, to ensure that individual UE which high signal format requirements do not spread in many groups, forcing the NW node to use the resource-consuming format for many UE groups. In one approach, the NW node can consider the average channel quality for grouping. The NW node can also consider the historical modulation and coding scheme (MCS) used by the UEs.

For UEs in mobility condition, the configuration used in the WUS transmission or the group in which the UE belongs to can be updated through Radio Resource Control (RRC) reconfiguration, e.g. based on the latest channel quality information. In another option, the UE and NW might also consider the worst-case channel quality the UE has inside a certain monitoring period.

Furthermore, the NW node may decide to group one UE to two or more groups. E.g., the NW node may expect the UE channel quality to change within a range and divide that range to several smaller ranges which corresponds to different groups. The NW node can dynamically address the UE within the appropriate group when the channel conditions changes, or even send a WUS to the UE within multiple groups (possibility with different time/frequency (T/F) WUS MO components) in case the channel conditions may change, but the NW node lack information how the conditions have changed.

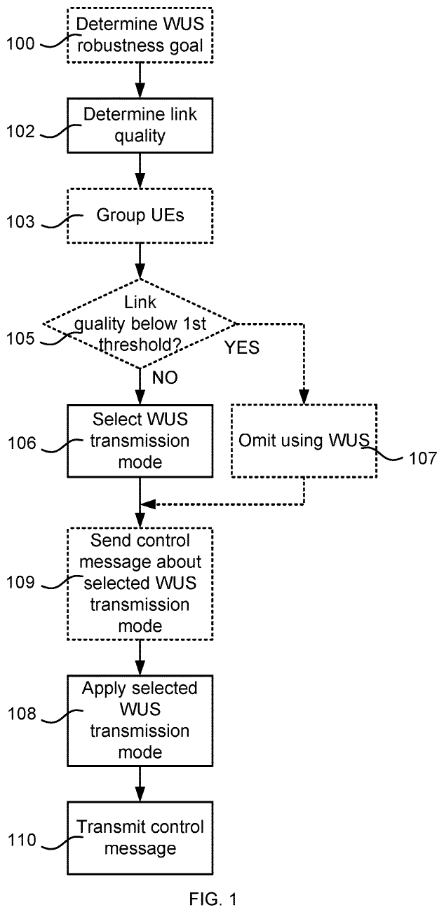

FIG. 1 is a flow chart illustrating methods according to embodiments. In the flow chart, boxes with hashed lines illustrate options, which are combinable according to the discussions in this disclosure.

The NW node determines 100 a WUS robustness goal. This may be predetermined or determined based on actual operation or service. The goal may for example be expressed as the probability of missed WUS detection at the UE.

The NW node also determines 102 link quality between the NW node and the UE. This determination may be based on an estimate, e.g. from historical transmissions, and/or based on reported link quality from the UE. This may be performed for a plurality of UEs individually, and the UEs may be grouped 103 based on the individual link qualities. It may be checked 105 whether the link quality is below a first threshold. If so, the NW node may determine 107 to omit using WUS since the use of WUS would not give a desired advantage under the given conditions. This can be seen as a special WUS transmission mode.

The NW node selects 106 a WUS transmission mode. A WUS transmission mode can be seen as a set of configuration parameters for the WUS operation, e.g. a configuration of at least one of signal type, signal format, power, payload size, code rate, bandwidth, aggregation level, modulation, etc. The WUS transmission mode is selected 106 based on the determined link quality, and for the case of grouped UEs, the selection can be made according to any of the approaches discussed above. The WUS transmission mode may further be based on a discontinuous reception configuration applied for the wireless device. The selection 106 may be updated, e.g. periodically or based on any occurred event, such as new reported quality parameters or mobility events. The selected WUS transmission mode may be signalled to the UE(s), e.g. through RRC signalling or other control signalling. The signalling may for example be performed upon updated or changed selection 106 of the WUS transmission mode. As discussed above, more than one WUS transmission move may be selected for a UE, and the signalling is adapted accordingly.

The grouping 103 may also be based on whether the UEs have same selected WUS transmission mode, have matching link quality as suggested above, have same allocated bandwidth, have same control information configuration, have same synchronisation configuration, or have same WUS monitoring occasion configuration, or any combination thereof.

The selected WUS transmission mode (or each one, or a selected one of the selected multiple WUS transmission modes) is (are) applied 108, wherein the WUS is transmitted, with the parameters according to the WUS transmission mode, at a time corresponding to a monitoring occasion (MO) for the UE. The UE is thus considered (with the likelihood determined by the WUS robustness goal) notified that a control message, e.g. PDDCH message, is about to come and should be ready for receiving the control message. The NW node thus transmits 110 the control message confidently that the UE is awake to receive it.

The NW node thus determines the required WUS reception robustness, e.g. permissible missed detection probability, based on other parameter settings used in the deployment, e.g. PDCCH and PDSCH target Block Error Rate (BLER). E.g., for 1% PDCCH error rate, the desired WUS missed detection rate may be below 0.1%.

The NW node obtains possible options (types, formats, etc.) for WUS configuration and their required channel/link quality for WUS reception according to the required robustness level. The options may differ and depend on the WUS signal type (e.g. PDCCH-based WUS, RS-based WUS, OOK WUS, etc.), signal format (different payload options, different Downlink Control Information (DCI) formats, Radio Network Temporary Identifier (RNTI), etc.), payload size and code rate (number of fields and their sizes), signal Transmit (TX) power (level of boosting in Orthogonal Frequency Division Multiplexing (OFDM)), BW (AL), interleaving, etc.

The NW node determines link quality for the UE based on e.g. UE measurement reports (e.g., Channel State Information Reference Signal (CSI-RS) reports), BM, LA reports, SRS transmission, etc. The quality metric may be in the form of Reference Signal Receive Power (RSRP), Signal-to-Interference and Noise Ratio (SINR), Channel Quality Indicator (CQI), etc. In other option, a historical MCS format might also be used. In situations where the receiver requirements are more relaxed for reception of the WUS compared to the reception of regular data, this would then be taken into account when determining the link quality. As a specific example, if the noise figure is 10 dB higher for the Wake-Up Radio (WUR), i.e. the receiver or receiver configuration used for receiving the WUS, than for the main radio, i.e. the receiver or receiver configuration used for non-WUS signals such as control signals or data transmissions, this link quality for the reception of the WUS would be assumed to be 10 dB worse than for the main radio. This difference in noise figure may either be caused by that a dedicated low power receiver, i.e. the receiver or receiver configuration used for receiving the WUS, is used for the reception of the WUS, or it may be due to that the gain in the receiver's LNA is reduced for the reception of the WUS in order to reduce the power consumption.

As stated above, the NW node selects one or more WUS transmission modes/formats based on the robustness and the link quality. The NW node may select the format that provides the required robustness for the estimated channel quality while requiring the least resources and/or providing the maximal signalling/payload capacity. The NW node may also consider UE operating constraints like the number of antennas or BW limits.

The NW node configures the UE to receive the selected WUS mode(s)/format(s). In some embodiments, the NW node may configure the UE to monitor multiple WUS formats and modes. For example, the UE may be configured to receive PDCCH-WUS, in 3GPP Rel-16 for New Radio (NR), according to a range of AL, interleaving options and payload size/format patterns. In another embodiment, the NW node may also determine not to configure WUS for the respected UE, e.g. due to very poor link quality, expected traffic, etc.

In yet another embodiment, the NW may send an explicit request to the device and ask whether reception of a WUS is feasible and in that case what format is required. Based on the response to this request, the NW node may select whether to configure a WUS mode or not.

The NW node transmits a WUS to the UE in conjunction with data transmission to the UE using (one of) the selected mode(s)/format(s).

For UE's with poor link conditions, the NW cost of WUS transmission with low missed detection probability may be high and might lead to a waste of PDCCH resources. To ensure sufficiently good performance, high power and wide BW may be used, leading to high impact on available PDCCH resources. In some cases, the NW node may select not to transmit WUS for such UEs. In such case, the UE is the not configured to monitor WUS.

In a related realization of this embodiment, the NW node can decide to configure or not configure WUS for a specific UE or a group of UEs, based on available PDCCH-WUS resources (or budget), UE's channel conditions, expected traffic from and to the UE, UE's history of reliable WUS detection, NW node buffer status, and so on. E.g., in one realization the NW node may decide to maximize the number of configured UEs with WUS for a specific PDCCH-WUS resource availability. In another realization, the NW may decide not to configure WUS for a UE, if the UE expects critical information of low latency.

In order to reduce the total PDCCH load associated with WUS, group-WUS transmission may be used targeting multiple UEs, and e.g. a bitmap in the DCI may indicate which UEs should wake up in the next on-duration. In such case, the group-WUS format is preferably selected to match the link quality of the UE with the worst channel in the group. In another approach, a group WUS-RNTI is associated to the UEs within the same group. If a UE belongs to different group, it may be associated with different group WUS-RNTIs. Yet, in another approach, the grouping can be done based on BWP, CORESET, Synchronization Signal (SS) configuration, WUS MO and so on.

In worst case, each group may have some UE with a poor channel, necessitating resource-costly WUS transmission in all groups. To avoid that, the NW node may group UEs to obtain groups with similar channel qualities, to ensure that e.g. individual poor UEs' signal format requirements do not result in having to spend a lot of resources in many groups. In that respect, UEs targeted in a given transmission should have similar signal quality requirements.

As mentioned above, a UE with very poor link quality would use resource-costly WUS transmission. This will force the group containing that UE to use the resource-costly WUS. In one approach, the NW node may decide that the UEs which have link quality below a certain threshold will not be included in any groups and does not transmit WUS for those respected UEs. In another approach, the respected UE may also be grouped to more than one groups, allowing the UE to monitor the WUS in more than WUS MO and increase its WUS detection probability.

Another aspect is to deal with WUS configuration for different Connected mode Discontinuous Reception (C-DRX) configuration modes, namely short and long DRX. In one approach, the NW node may decide to configure WUS for the long DRX but not for the short DRX, or other way around, or configure or not configure for both.

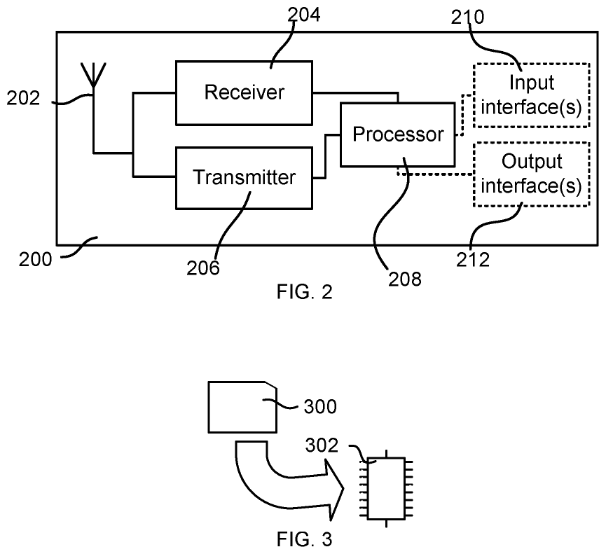

FIG. 2 is a block diagram schematically illustrating a NW node 200 according to an embodiment. The NW node 200 comprises an antenna arrangement 202, a receiver 204 connected to the antenna arrangement 202, a transmitter 206 connected to the antenna arrangement 202, a processing element 208 which may comprise one or more circuits, one or more input interfaces 210 and one or more output interfaces 212. The interfaces 210, 212 can be user interfaces and/or signal interfaces, e.g. electrical or optical. The NW node 200 is arranged to operate in a cellular communication network. In particular, by the processing element 208 being arranged to perform the embodiments demonstrated with reference to FIG. 1, the NW node 200 is capable of transmitting control signals to one or more wireless devices which enables the wireless devices to save energy through efficient and balanced use of WUS. The processing element 208 can also fulfil a multitude of tasks, ranging from signal processing to enable reception and transmission since it is connected to the receiver 204 and transmitter 206, executing applications, controlling the interfaces 210, 212, etc.

The methods according to the present disclosure is suitable for implementation with aid of processing means, such as computers and/or processors, especially for the case where the processing element 208 demonstrated above comprises a processor handling the balanced selection of WUS transmission mode. Therefore, there is provided computer programs, comprising instructions arranged to cause the processing means, processor, or computer to perform the steps of any of the methods according to any of the embodiments described with reference to FIG. 1. The computer programs preferably comprise program code which is stored on a computer readable medium 300, as illustrated in FIG. 3, which can be loaded and executed by a processing means, processor, or computer 302 to cause it to perform the methods, respectively, according to embodiments of the present disclosure, preferably as any of the embodiments described with reference to FIG. 1. The computer 302 and computer program product 300 can be arranged to execute the program code sequentially where actions of the any of the methods are performed stepwise, or be performed on a real-time basis. The processing means, processor, or computer 302 is preferably what normally is referred to as an embedded system. Thus, the depicted computer readable medium 300 and computer 302 in FIG. 3 should be construed to be for illustrative purposes only to provide understanding of the principle, and not to be construed as any direct illustration of the elements.

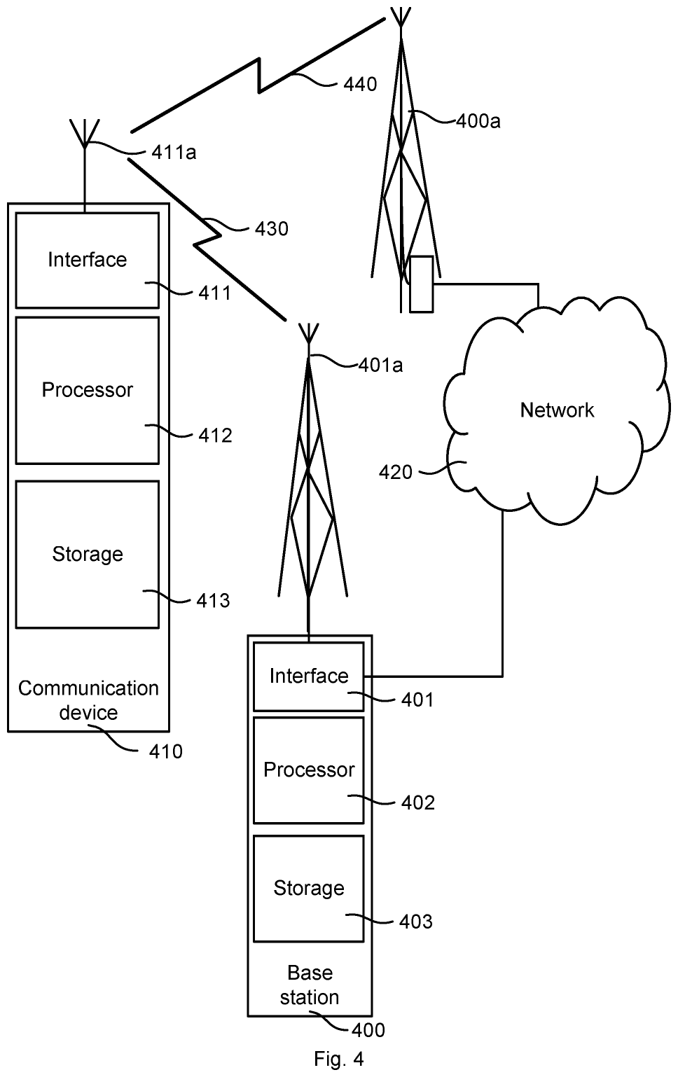

FIG. 4 illustrates a wireless network comprising NW nodes 400 and 400a and a wireless device 410 with a more detailed view of the network node 400 and the communication device 410 in accordance with an embodiment. For simplicity, FIG. 4 only depicts core network 420, network nodes 400 and 400a, and communication device 410. Network node 400 comprises a processor 402, storage 403, interface 401, and antenna 401a. Similarly, the communication device 410 comprises a processor 412, storage 413, interface 411 and antenna 411a. These components may work together in order to provide network node and/or wireless device functionality as demonstrated above. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

The network 420 may comprise one or more IP networks, public switched telephone networks (PSTNs), packet data networks, optical networks, wide area networks (WANs), local area networks (LANs), wireless local area networks (WLANs), wired networks, wireless networks, metropolitan area networks, and other networks to enable communication between devices. The network 420 may comprise a network node for performing the method demonstrated with reference to FIG. 1, and/or an interface for signalling between network nodes 400, 400a.

The network node 400, which for example can be a NodeB such as a gNodeB, or an Access Point (AP), comprises a processor 402, storage 403, interface 401, and antenna 401a. These components are depicted as single boxes located within a single larger box. In practice however, a network node may comprise multiple different physical components that make up a single illustrated component (e.g., interface 401 may comprise terminals for coupling wires for a wired connection and a radio transceiver for a wireless connection). Similarly, network node 400 may be composed of multiple physically separate components (e.g., a NodeB component and core network component, etc.), which may each have their own respective processor, storage, and interface components. In certain scenarios in which network node 400 comprises multiple separate components, one or more of the separate components may be shared among several network nodes. For example, a single Radio Network Controller (RNC) or cloud-based controller may control multiple NodeBs. In such a scenario, each unique NodeB and controller pair, may be a separate network node. In some embodiments, network node 400 may be configured to support multiple radio access technologies (RATs). In such embodiments, some components may be duplicated (e.g., separate storage 403 for the different RATs) and some components may be reused (e.g., the same antenna 401a may be shared by the RATs).

The processor 402 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other network node 400 components, such as storage 403, network node 400 functionality. For example, processor 402 may execute instructions stored in storage 403. Such functionality may include providing various wireless features discussed herein to a wireless device, such as the wireless device 410, including any of the features or benefits disclosed herein.

Storage 403 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 403 may store any suitable instructions, data or information, including software and encoded logic, utilized by the network node 400. the storage 403 may be used to store any calculations made by the processor 402 and/or any data received via the interface 401.

The network node 400 also comprises the interface 401 which may be used in the wired or wireless communication of signalling and/or data between network node 400, network 420, and/or wireless device 410. For example, the interface 401 may perform any formatting, coding, or translating that may allow network node 400 to send and receive data from the network 420 over a wired connection. The interface 401 may also include a radio transmitter and/or receiver that may be coupled to or a part of the antenna 401a. The radio may receive digital data that is to be sent out to other network nodes or wireless devices via a wireless connection. The radio may convert the digital data into a radio signal having the appropriate channel and bandwidth parameters. The radio signal may then be transmitted via antenna 401a to the appropriate recipient (e.g., the wireless device 410).

The antenna 401a may be any type of antenna capable of transmitting and receiving data and/or signals wirelessly. In some embodiments, antenna 401a may comprise one or more omnidirectional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. The antenna 401a may comprise one or more elements for enabling different ranks of SIMO, MISO or MIMO operation.

The wireless device 410 may be any type of communication device, wireless device, UE, D2D device or ProSe UE, station (STA), etc. but may in general be any device, sensor, smart phone, modem, laptop, Personal Digital Assistant (PDA), tablet, mobile terminal, smart phone, laptop embedded equipped (LEE), laptop mounted equipment (LME), Universal Serial Bus (USB) dongles, machine type UE, UE capable of machine to machine (M2M) communication, etc., which is able to wirelessly send and receive data and/or signals to and from a network node, such as network node 400 and/or other wireless devices. In particular, the wireless device 410 is capable of communication as demonstrated above, e.g. in a . . . context. The wireless device 410 comprises a processor 412, storage 413, interface 411, and antenna 411a. Like the network node 400, the components of the wireless device 410 are depicted as single boxes located within a single larger box, however in practice a wireless device may comprises multiple different physical components that make up a single illustrated component (e.g., storage 413 may comprise multiple discrete microchips, each microchip representing a portion of the total storage capacity).

The processor 412 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in combination with other wireless device 410 components, such as storage 413, wireless device 410 functionality. Such functionality may include providing various wireless features discussed herein, including any of the features or benefits disclosed herein.

The storage 413 may be any form of volatile or non-volatile memory including, without limitation, persistent storage, solid state memory, remotely mounted memory, magnetic media, optical media, random access memory (RAM), read-only memory (ROM), removable media, or any other suitable local or remote memory component. The storage 413 may store any suitable data, instructions, or information, including software and encoded logic, utilized by the wireless device 410. The storage 413 may be used to store any calculations made by the processor 412 and/or any data received via the interface 411.

The interface 411 may be used in the wireless communication of signalling and/or data between the wireless device 410 and the network nodes 400, 400a. For example, the interface 411 may perform any formatting, coding, or translating that may allow the wireless device 410 to send and receive data to/from the network nodes 400, 400a over a wireless connection. The interface 411 may also include a radio transmitter and/or receiver that may be coupled to or a part of the antenna 411a. The radio may receive digital data that is to be sent out to e.g. the network node 401 via a wireless connection. The radio may convert the digital data into a radio signal having the appropriate channel and bandwidth parameters. The radio signal may then be transmitted via the antenna 411a to e.g. the network node 400.

The antenna 411a may be any type of antenna capable of transmitting and receiving data and/or signals wirelessly. In some embodiments, antenna 411a may comprise one or more omnidirectional, sector or panel antennas operable to transmit/receive radio signals between 2 GHz and 66 GHz. For simplicity, antenna 411a may be considered a part of interface 411 to the extent that a wireless signal is being used. The antenna 411a may comprise one or more elements for enabling different ranks of SIMO, MISO or MIMO operation.

In some embodiments, the components described above may be used to implement one or more functional modules used for enabling measurements as demonstrated above. The functional modules may comprise software, computer programs, sub-routines, libraries, source code, or any other form of executable instructions that are run by, for example, a processor. In general terms, each functional module may be implemented in hardware and/or in software. Preferably, one or more or all functional modules may be implemented by the processors 412 and/or 402, possibly in cooperation with the storage 413 and/or 403. The processors 412 and/or 402 and the storage 413 and/or 403 may thus be arranged to allow the processors 412 and/or 402 to fetch instructions from the storage 413 and/or 403 and execute the fetched instructions to allow the respective functional module to perform any features or functions disclosed herein. The modules may further be configured to perform other functions or steps not explicitly described herein but which would be within the knowledge of a person skilled in the art.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features

### This Disclosure May be Summarized by the Following Items

1. A method of transmitting control information in a wireless communication system to a wireless device performed by a network node of the wireless communication system, the method comprising

determining a wake-up signal, WUS, transmission robustness goal;

determining a link quality between the network node and the wireless device;

selecting a WUS transmission mode based on the robustness goal and the link quality;

applying the selected WUS transmission mode such that a transmitted WUS enables the wireless device to wake up to receive control information; and

transmitting the control information to the wireless device.

2. The method of item 1, comprising transmitting a control message to the wireless device about the selected WUS transmission mode.

3. The method of item 1 or 2, wherein the selecting of the WUS transmission mode comprises selecting a WUS transmission mode implicating not applying a WUS when link quality is below a first threshold, and selecting a WUS transmission mode implicating applying a WUS when link quality is above the first threshold.

4. The method of any one of items 1 to 3, wherein the selected WUS mode comprises a configuration of at least one of:

search space and control resource set;

bandwidth part;

offset in time or frequency;

signal type;

signal format;

power;

payload size;

code rate;

bandwidth;

aggregation level; and

modulation and coding.

5. The method of any one of items 1 to 4, wherein the determining of the WUS transmission robustness goal is based on a maximum WUS missed detection rate.

6. The method of any one of items 1 to 5, comprising grouping a plurality of wireless terminals into a group; and

transmitting control information to the wireless terminals of the group.

7. The method of item 6, wherein the plurality of wireless devices of the group are grouped based on

having same selected WUS transmission mode,

having matching link quality,

having same allocated bandwidth,

having same control information configuration,

having same synchronisation configuration, or

having same WUS monitoring occasion configuration, or

any combination thereof.

8. The method of any one of items 1 to 7, wherein the selection of the WUS transmission mode is further based on a discontinuous reception configuration applied for the wireless device.

9. A network node arranged to transmit control information in a wireless communication system to a wireless device, the network node comprising a transceiver and a controller, wherein

the controller is arranged to determine a wake-up signal, WUS, transmission robustness goal, determine a link quality between the network node and the wireless device, select a WUS transmission mode based on the robustness goal and the link quality, and applying the selected WUS transmission mode, and

the transceiver is arranged to transmit the control information to the wireless device.

10. The network node of item 9, wherein the controller is arranged to provide a control message about the selected WUS transmission mode, and the transceiver is arranged to transmit the control message to the wireless device about the selected WUS transmission mode.

11. The network node of item 9 or 10, wherein the controller is arranged to select the WUS transmission mode by selecting a WUS transmission mode implicating not applying a WUS when link quality is below a first threshold, and selecting a WUS transmission mode implicating applying a WUS when link quality is above the first threshold.

12. The network node of any one of items 9 to 11, wherein the selected WUS mode comprises a configuration of at least one of:

search space and control resource set;

bandwidth part;

offset in time or frequency;

signal type;

signal format;

power;

payload size;

code rate;

bandwidth;

aggregation level; and

modulation and coding.

13. The network node of any one of items 9 to 12, wherein the controller is arranged to determine the WUS transmission robustness goal based on a maximum WUS missed detection rate.

14. The network node of any one of items 9 to 13, wherein the controller is arranged to group a plurality of wireless terminals into a group, and the transceiver is arranged to transmit control information to the wireless terminals of the group.

15. The network node of item 14, wherein the plurality of wireless devices of the group are grouped based on

having same selected WUS transmission mode,

having matching link quality,

having same allocated bandwidth,

having same control information configuration,

having same synchronisation configuration, or

having same WUS monitoring occasion configuration, or

any combination thereof.

16. The network node of any one of items 9 to 15, wherein the controller is arranged to select the WUS transmission mode based on a discontinuous reception configuration applied for the wireless device.

17. A computer program comprising instructions which, when executed on a processor of a network node causes the network node to perform the method according to any of items 1 to 8.

1. A method of transmitting control information in a wireless communication system to a wireless device performed by a network node of the wireless communication system, where at least two wake-up signal, WUS, transmission modes are selectable, the method comprising:
determining a link quality between the network node and the wireless device;
selecting a WUS transmission mode based on the link quality; and
applying the selected WUS transmission mode such that when transmitting the control information to the wireless device, the wireless device is enabled to be awake to receive the control information.

2. The method of claim 1, wherein the selecting of the WUS transmission mode comprises selecting a WUS transmission mode implicating not applying a WUS when link quality is below a first threshold, and selecting a WUS transmission mode implicating applying a WUS when link quality is above the first threshold.

3. The method of claim 1, comprising configuring, by the network node, the wireless device to the selected WUS transmission mode.

4. The method of claim 3, wherein the configuring of the wireless device comprises transmitting a control message to the wireless device about the selected WUS transmission mode.

5. The method of claim 1, comprising determining a WUS transmission robustness goal, wherein the selecting of the WUS transmission mode is further based on the WUS transmission robustness goal.

6. The method of claim 5, wherein the determining of the WUS transmission robustness goal is based on a maximum allowable WUS missed detection rate.

7. The method of claim 1, wherein the determining of the link quality to use for the selecting of the WUS transmission mode is based on at least one of:
measurement reports from the wireless device including at least one of:
Channel State Information Reference Signal, CSI-RS, report;
beam management, BM, report;
link adaptation, LA, report; and
sounding reference signal, SRS, transmission;
quality metric including at least one of:
Reference Signal Receive Power, RSRP;
Signal-to-Interference and Noise Ratio, SINR; and
Channel Quality Indicator, CQI;
a historical modulation and coding scheme, MCS, format for WUS; and
a noise figure relation between one of a Wake-Up Radio, WUR, receiver and receiver configuration used for receiving the WUS, and one of a receiver and receiver configuration used for non-WUS signals.

8. The method of claim 1, wherein the selected WUS mode comprises a configuration of at least one of:
search space and control resource set;
bandwidth part;
offset in time or frequency;
signal type;
signal format;
power;
payload size;
code rate;
bandwidth;
aggregation level; and
modulation and coding.

9. The method of claim 1, comprising:
grouping a plurality of wireless terminals into a group; and
transmitting control information to the wireless devices of the group.

10. The method of claim 9, wherein the plurality of wireless devices of the group are grouped based on at least one of:
having same selected WUS transmission mode;
having matching link quality;
having same allocated bandwidth;
having same control information configuration;
having same synchronisation configuration; and
having same WUS monitoring occasion configuration.

11. The method of claim 9, comprising transmitting a group-WUS targeting multiple wireless devices, wherein a group-WUS format is selected to match a link quality of the wireless device with a worst channel in the group comprising the multiple wireless devices.

12. The method of claim 9, wherein a bitmap in Downlink Control Information, DCI, indicates which wireless devices should wake up in a next on-duration.

13. The method of claim 9, wherein a group WUS-Radio Network Temporary Identifier, RNTI, is associated to the wireless devices within a same group.

14. The method of claim 1, wherein the selection of the WUS transmission mode is further based on a discontinuous reception configuration applied for the wireless device.

15. A network node configured to transmit control information in a wireless communication system to a wireless device, where at least two wake-up signal, WUS, transmission modes are selectable, the network node comprising:
a transceiver; and
a controller, the controller being configured to determine a link quality between the network node and the wireless device, select a WUS transmission mode based on the link quality, and applying apply the selected WUS transmission mode such that when the transceiver transmits the control information to the wireless device, the wireless device is enabled to be awake to receive the control information.

16. The network node of claim 15, wherein the controller is configured to select the WUS transmission mode by selecting a WUS transmission mode implicating not applying a WUS when link quality is below a first threshold, and to select a WUS transmission mode implicating applying a WUS when link quality is above the first threshold.

17. The network node of claim 15, wherein the controller is configured to configure the wireless device to the selected WUS transmission mode.

18. The network node of claim 17, wherein the controller is configured to configure the wireless device by providing a control message about the selected WUS transmission mode, and the transceiver is configured to transmit the control message to the wireless device about the selected WUS transmission mode.

19. The network node of claim 15, wherein the controller is configured to determine a wake-up signal, WUS, transmission robustness goal, and further configured to select the WUS transmission mode based on the WUS transmission robustness goal.

20. The network node of claim 19, wherein the controller is configured to determine the WUS transmission robustness goal based on a maximum allowable WUS missed detection rate.

21. The network node of claim 15, wherein the link quality to use for the selection of the WUS transmission mode is based on at least one of:
measurement reports from the wireless device including at least one of:
Channel State Information Reference Signal, CSI-RS, report;
beam management, BM, report;
link adaptation, LA, report; and
sounding reference signal, SRS, transmission;
a quality metric including at least one of:
Reference Signal Receive Power, RSRP;
Signal-to-Interference and Noise Ratio, SINR; and
Channel Quality Indicator, CQI;
a historical modulation and coding scheme, MCS, format for WUS; and
a noise figure relation between one of a Wake-Up Radio, WUR, receiver and receiver configuration used for receiving the WUS, and one of a receiver and receiver configuration used for non-WUS signals.

22. The network node of any claim 15, wherein the selected WUS mode comprises a configuration of at least one of:
search space and control resource set;
bandwidth part;
offset in time or frequency;
signal type;
signal format;
power;
payload size;
code rate;
bandwidth;
aggregation level; and
modulation and coding.

23. The network node of claim 15, wherein the controller is configured to group a plurality of wireless terminals into a group, and the transceiver is configured to transmit control information to the wireless terminals of the group.

24. The network node of claim 23, wherein the
having same selected WUS transmission mode;
having matching link quality;
having same allocated bandwidth;
having same control information configuration;
having same synchronisation configuration; and
having same WUS monitoring occasion configuration.

25. The network node of claim 23, configured to transmit a group-WUS targeting multiple wireless devices, wherein a group-WUS format is selected to match a link quality of the wireless device with a worst channel in the group comprising the multiple wireless devices.

26. The network node of claim 23, wherein a bitmap in Downlink Control Information, DCI, indicates which wireless devices should wake up in a next on-duration.

27. The network node of claim 23, wherein a group WUS-Radio Network Temporary Identifier, RNTI, is associated to the wireless devices within a same group.

28. The network node of claim 15, wherein the controller is arranged to select the WUS transmission mode based on a discontinuous reception configuration applied for the wireless device.

29. A computer storage medium storing a computer program comprising instructions which, when executed on a processor of a network node causes the network node to perform the a method of transmitting control information in a wireless communication system to a wireless device, where at least two wake-up signal, WUS, transmission modes are selectable, the method comprising:
determining a link quality between the network node and the wireless device;
selecting a WUS transmission mode based on the link quality; and
applying the selected WUS transmission mode such that when transmitting the control information to the wireless device, the wireless device is enabled to be awake to receive the control information.
